(19) United States
(12) Patent Application Publication
(10) Pub. No.: US 2005/0123210 A1
(43) Pub. Date: Jun. 9, 2005

(54) Print processing of compressed noisy images

(76) Inventor: Anoop K. Bhattacharjya, Campbell, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/729,664

(22) Filed: Dec. 5, 2003

(51) Int. Cl. G06K 9/00; G06K 9/36

(52) U.S. Cl. 382/254; 382/250

(57) ABSTRACT

A fast technique utilizes overcomplete DCT representations and performs de-blocking, de-noising and de-blurring by thresholding and transforming the transform coefficients to process images obtained from inexpensive sensors/cameras with low-quality compressed image output. A color balance algorithm is used to compensate for hue shifts. Quality differences between color channels and inter-channel correlations are exploited to significantly reduce computational requirements and yield a high-performance technique for processing such images before printing.

### BACKGROUND OF THE INVENTION

1. Field of the Invention

The present invention relates to a technique for processing compressed noisy images. The technique enables fast processing of such data by processing one color of data and reconstructing the other color data based on the processed and unprocessed data of the first color. The technique may be embodied in an apparatus (e.g., a computer), in a device (e.g., an integrated circuit chip), or as a program of instructions (e.g., software) embodied on a machine-readable medium.

2. Description of the Related Art

Inexpensive CMOS sensors are widely used in many low-cost, low-power devices such as camera-equipped cell phones, web cams, PDAs, robots, etc. The images output from such devices typically suffer from low resolution and poor signal-to-noise ratio. In addition to the degradation from sensor noise, such images also contain artifacts resulting from cost-saving measures such as the use of “mosaiced” sensors that sample the light field at different spatial densities for red, green and blue color components (so that a single sensor in which different spatial locations are sensitive to different spectral components can be used), and the use of simple optics in the form of plastic lenses with small fixed apertures. The process of interpolating color components at each pixel from measured neighboring samples is referred to as “demosaicing.” Since the human eye is most sensitive to the green-yellow part of the visible spectrum, most mosaiced sensors are built with a preponderance of green-sensitive elements. Often such sensors contain twice as many green-sensitive elements as red- or blue-sensitive elements. To reduce image storage memory requirements, these sensors are often coupled with image compression modules that compress the sensor-collected data using a popular compression algorithm, e.g., JPEG. The compression of noisy data with JPEG, however, often produces blocky image artifacts. While such noisy, artifact-containing images are reasonably acceptable for viewing on small image displays such as on cell-phones or PDAs, their quality further deteriorates when they are scaled up. Hence, such images are unsuitable for rendering on a high-resolution device such as an ink-jet printer. In addition to noise, blocky artifacts and/or blur related problems, some images (e.g., images of indoor scenes in fluorescent lighting) also suffer from hue shifts.

### OBJECTS OF THE INVENTION

Accordingly, it is an object of the present invention to overcome the above-mentioned problems and provide a technique for processing images suffering from noise, artifacts, blur and/or hue shift.

It is another object of this invention to provide a fast technique that is designed for processing images obtained from inexpensive sensors/cameras with low-quality compressed image output.

### SUMMARY OF THE INVENTION

According to one aspect of this invention, a method for processing compressed, noisy digital images is provided. The method comprises (a) processing initial first color data of an image to obtain reconstructed first color data thereof by (a)(1) computing a transform representation of initial first color data for each of a plurality of blocks of the image, each computed transform representation comprising a plurality of transform coefficients, (a)(2) thresholding (e.g., soft-thresholding) and scaling the transform coefficients in each block, and (a)(3) inverting the thresholded and scaled transform coefficients in each block to determine a reconstructed first color value for a designated pixel each block. Additionally, the method comprises (b) determining spatially local maps between at least a portion of the initial first color data and at least corresponding portions of each of initial second and third color data of the image; and (c) estimating reconstructed second and third color values for the designated pixel in each block from selected reconstructed first color values obtained in step (a) using the maps determined in step (b) to obtain reconstructed second and third color data of the image.

Preferably, each of the plurality of blocks encompasses a neighborhood of pixels, and each block has a respective designated pixel for which the reconstructed first color value is determined.

Preferably, processing step (a) is performed until a reconstructed first color value has been determined for each pixel in a particular neighborhood before proceeding to steps (b) and (c) in which reconstructed second and third color values are estimated for the corresponding designated pixel from the reconstructed first color values in that neighborhood. That is, the estimation of reconstructed second and third color values for a pixel begins as soon as reconstructed first color values for all pixels in the neighborhood (from which the reconstructed red and blue values are to be estimated) are determined. Thus, the processing of second and third color data slightly lags the processing of first color data, but it is not necessary to wait until the first color data has been completely processed before starting to process the second and third color data. The second and third color data may be processed in parallel.

In preferred embodiments, the first color data is green color data, the second color data is red color data, and the third color data is blue color data.

The method may further comprise the step(s) of performing a hue shift on the reconstructed green, red and blue color data, and/or interpolating the reconstructed image data to a different resolution.

In another aspect, the invention involves an apparatus, which may be a computer or a printer, for processing compressed, noisy digital images. The apparatus comprises a transform domain processing module that further includes a transform block processor and a transform coefficient processor. A reconstruct module is also part of the apparatus. In some embodiments, the apparatus further includes a hue shift module and/or an interpolation module. Each of these modules is configured to perform the processing associated therewith. Each module may be conveniently implemented in software, or alternatively with hardware. In the latter case, the hardware may include one or more of the following: an instruction-based processor (e.g., a central processing unit (CPU)), an Application Specific Integrated Circuit (ASIC), digital signal processing circuitry, or combination thereof.

In accordance with further aspects of the invention, the above-described method or any of the steps thereof may be embodied in a program of instructions (e.g., software) which may be stored on, or conveyed to, a computer or other processor-controlled device for execution. Alternatively, the method or any of the steps thereof may be implemented using functionally equivalent hardware (e.g., ASIC, digital signal processing circuitry, etc.) or a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a flow diagram illustrating processing steps of an algorithm/method for compressed, noisy images, according to embodiments of the invention.

FIG. 2 is a block diagram of a unit configured to perform image processing according to embodiments of the invention.

FIG. 3 is a block diagram of an exemplary image processing system which may be used to implement embodiments of the algorithm/method of the present invention.

### DESCRIPTION OF THE PREFERRED EMBODIMENTS

A. Method/Algorithm

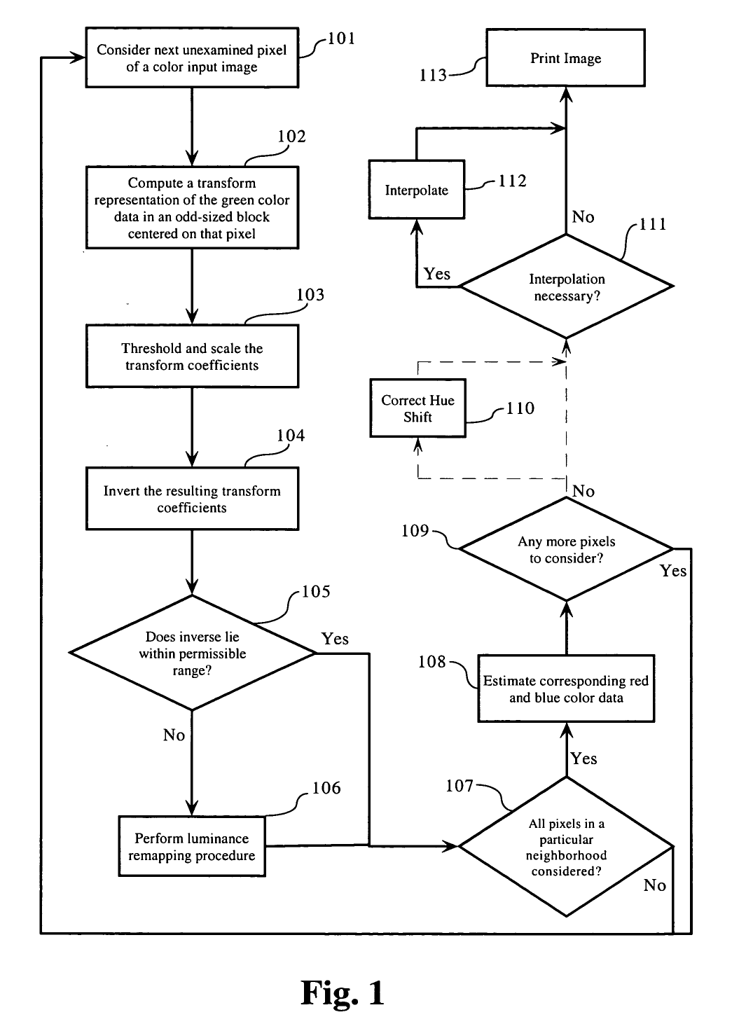

Referring to the flow diagram of FIG. 1, the algorithm/method of the present invention begins in step 101 by considering an unexamined pixel of a color (RGB) input image. Next, a transform (e.g., a Discrete Cosine Transform (DCT)) representation of the green color data is computed in an odd-sized block centered on that pixel (step 102). Since the center pixel is entirely determined by about 25% of the transform coefficients most of the coefficients of the complete transform representation need not be computed. In step 103, the transform coefficients are thresholded and scaled. The thresholds and scaling factors may be preset at the factory or determined for each device by any suitable calibration procedure. The thresholding effectively reduces noise, while the scaling de-blurs the input image.

The resulting coefficients are then inverted to determine a reconstructed green color value for the center pixel (step 104). As a result of modifying the transform coefficients, the inverse may not lie within the range of permissible values for a pixel. That decision is made in step 105. If the inverse does not lie within the permissible range, a luminance remapping procedure is used in step 106 to map the result of the transform inverse (e.g., DCT inverse) to the allowed range.

Flow continues with step 107, where it is determined if all pixels in a particular neighborhood have been considered. If not, the algorithm loops back to step 101 where the next pixel is obtained, and steps 102 through 106 are repeated for that pixel. However, as soon as reconstructed green color values are obtained for all pixels in a given neighborhood of suitable size (e.g., 3×3 or 5×5), the algorithm continues to step 108 where corresponding the red and blue color values for the neighborhood's subject (e.g., center) pixel are reconstructed and estimated. Such red and blue color data are reconstructed by first determining spatially local maps between the green color data and the red and blue color data using the unprocessed (i.e., noisy) image data. These maps are then used to estimate the red and blue channels values for the neighborhood's subject pixel from the reconstructed green channel values of the neighborhood of pixels. A fast implementation could use, for example, the ratio of local means to scale the reconstructed green channel to estimate the red and blue channels of the image. This step exploits local spatial correlation between the color channels, and the fact that the quality of the green channel is much superior to the red and blue channels owing to the higher density and superior spectral response of the green-sensitive sensor elements in the sensor.

Next, in step 109, it is determined whether or not there are any more pixels in the input image to consider. If so, the algorithm loops back to step 101 where the next unexamined pixel is considered. This pixel will be the first in a new neighborhood of pixels, and will be subjected to the processing of steps 101-108 in the inside loop. After a complete set of reconstructed data for each color channel has been obtained, the algorithm continues with some post-reconstruction processing.

In optional step 110, hue shift can be corrected by making the well-known gray-world assumption. According to this assumption, the average of all colors in an image should be approximately gray. Thus, to perform hue adjustment, an average color is computed by averaging the colors of all the pixels in the image. If the computed average has sufficiently high luminance and is not significantly different from gray (i.e., all color components have substantially the same strength), the deviation of the average from gray can be subtracted from all pixels to compensate for the hue shift. In practice, a smaller scaled version of the deviation is subtracted from all pixels, and the resulting colors are clipped to the permissible color range to perform hue adjustment. The selective application of the hue-shift-correction algorithm attempts to ensure that the images taken under special lighting conditions for special visual effects (e.g., sunsets, dance floors, etc.) are not always adversely affected. As noted above, this step may be skipped.

Before printing, the processed image may need to be interpolated to a different (higher) resolution. Thus, a decision is made in step 111 as to whether such interpolation is necessary, and if so, it is carried out in step 112. A simple bilinear interpolation method, which has a low requirement of processing and memory resources, may be used. However, bilinear interpolation has a smoothing effect on the image. This effect can be compensated for by adjusting the scaling factors in step 103 to generate slightly over-sharpened images that look visually appealing when interpolated using bilinear interpolation. After step 112 (or step 111 if interpolation is deemed unnecessary), the image is printed in step 113.

B. Additional Details

B.1 DCT Computations

Here, the task of computing DCTs in a window centered at each pixel is considered. For simplicity, the analysis below is performed for one-dimensional data. Since two-dimensional DCTs are equivalent to two cascaded one-dimensional DCTs, extending the analysis to two dimensions is straightforward. Consider the problem of computing DCTs for one-dimensional data. The elements of the one-dimensional array are denoted {xᵢ}. Consider a window containing N_{w} elements that is centered at the k^{th} data element. Denote this window by Wₖ, where
Wₖ={x_{k+n-R}_{_{w}}:n=0, . . . ,N_{w}−1,R_{w}=┘N_{w}/2┘}. (1)
Windows around boundary pixels are populated by periodically extending the one-dimensional data by reflection about the boundary. Denote the DCT coefficients for such a window Wₖ by {γᵣ^{(k)}: r=0, . . . , N_{w}−1}, where

$${γ}_{r}^{( k )} ≡ {\sum }_{n = 0}^{{N}_{w} - 1} {x}_{k + n - {R}_{w}} cos [ r π \frac{2 n + 1}{2 {N}_{w}} ] . \qquad ( 2 )$$

If the window size N_{w} is chosen to be an odd number, the center pixel of the k^{th} window has a particularly simple form, given by

$${x}_{k} = \frac{1}{{N}_{w}} [ {γ}_{0}^{( k )} + 2 {\sum }_{r = 1}^{{R}_{w}} {{γ}_{2 r}^{( k )} ( - 1 )}^{r} ] . \qquad ( 3 )$$

Thus, as indicated previously, only the even DCT coefficients need to be computed to recover the center pixel from the transform of data in an odd-sized window around it.

B.2. Mapping Color Channels

As previously discussed, the green color channel typically has the highest quality data, benefiting from the higher spatial sampling and better spectral response of the sensor for this color channel. The red and blue channels are typically noisier and sampled more sparsely in the sensor. Since computing transform coefficients, modifying some of them, and inverting the results is computationally expensive, this invention advantageously employs less expensive models to predict the red and blue channels from the green channel, and uses these models to reconstruct the red and blue channels using the reconstructed green channel. Models having estimation and prediction operations that are cheaper than the operations of independently processing the red and blue channels using the DCT-based reconstruction algorithm will result in proportional computational savings.

The specific approximation used in building the estimation/prediction models for the red and blue channels from the green channel is the observation that if each color channel is thought of as defining a two-dimensional surface over pixel locations, in a small neighborhood of a pixel, the surface profiles may be related to each other via simple linear maps. At a given pixel location (x, y) let f_{x,y}^{Red} and f_{x,y}^{Blue} be maps that relate the green color channel to the red and blue channels, respectively. If f*_{x,y}( ) is linear, it is fully specified by two parameters, α and β, where f*_{x,y}:t→αt+β. The parameters α and β may be determined locally at each location using a least-squares algorithm over color data defined in a small neighborhood around the location.

The above-described maps are constructed using color data from the image retrieved from the sensor. The processing of the red and blue channels for a pixel begins as soon as the green channel has been processed (de-noised and de-blurred) for all pixels belonging to the neighborhood from which the red and blue transformations are estimated. Thus, the processing of the red and blue channels slightly lag the processing of the green channel, but it is not necessary to wait until the green channel has been completely processed before starting to process the red and blue channels. The red and blue channels may be processed in parallel.

Another way to obtain new values for the red and blue channels from the corresponding processed green channel value is to scale the processed green channel value at each pixel by a factor equal to the ratio of the local mean of the desired channel (red or blue) and the local mean of the green channel, in a neighborhood of the pixel, in the input image.

B.3. Modifying DCT Coefficients

DCT coefficients are modified by soft thresholding, followed by scaling to determine the de-noised and de-blurred color at the center of each window, as previously described. Soft thresholding uses a smooth non-increasing function to reduce the amplitude of DCT coefficients corresponding to high frequencies. This operation reduces image noise. The scaling function is applied to the thresholded DCT coefficients to increase the amplitude of the high-frequency DCT coefficients that are non-zero after the thresholding operation. A variety of functions, e.g., tensor product of decreasing sigmoids, tensor product of decreasing unit step functions convolved with a Gaussian filter, etc., may be used to implement the soft-thresholding operation, which de-blurs and sharpens the image.

The parameters of the soft thresholding and scaling operations may be obtained by examining images obtained by the sensor for some test scenes. The DCT of the image of a smoothly illuminated scene with low color gradients, essentially contains noise for the mid- and high-frequency coefficients. The threshold for each DCT coefficient may be set to the corresponding coefficient for the DCT of a smooth scene scaled by an experimentally determined factor that optimizes perceived image quality.

The soft-thresholded DCT of a sharp image transition (e.g., image of a black circle on a white background), may be used to determine the scaling factor required for each DCT coefficient to reduce image blurring. The scaling factors for each coefficient are preferably ratios between the DCT coefficients of the ideal image (e.g., black circle on white background) and the corresponding non-zero DCT coefficients that survive the soft thresholding operation. Due to the susceptibility of this process to noise, in a preferred embodiment a parabolic surface is fitted to the estimated scaling factors for each qualified DCT coefficient, and a uniformly scaled version of this surface is used to perform the scaling operation. While a parabolic surface is preferred for this fitting, any other low-dimensional, radially symmetric, non-decreasing surface may be used instead. The scaling factor for scaling the estimated surface is determined experimentally to optimize perceived image quality.

C. Implementations

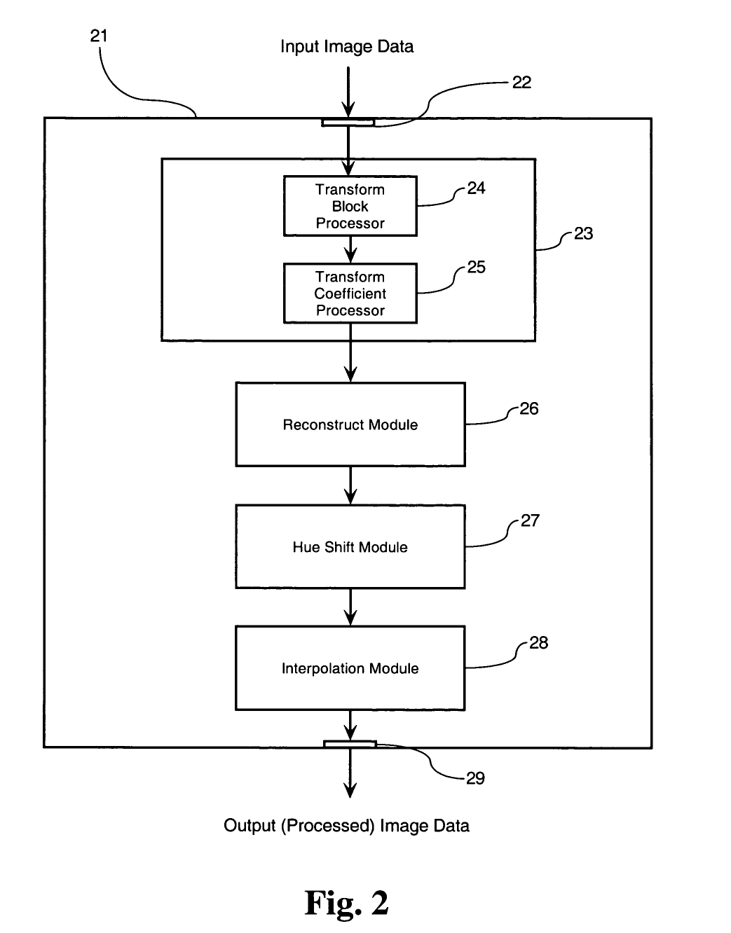

The algorithm/method of the present invention may be conveniently implemented in software. Alternatively, the algorithm/method of this invention may be implemented in hardware or in a combination of hardware and software. With that in mind, FIG. 2 illustrates a unit 21, which may represent an apparatus or device configured with software and/or hardware to carry out the processing in accordance with the invention. The processing carried out by unit 21 is represented by various modules. Input image data representing a compressed input image that suffers from noise, blurring, etc., as described above, is received through an input 22 and conveyed to a transform domain processing module 23 which includes the following processing modules: a transform block processor 24 configured to compute a transform representation of first (e.g., green) color data in an odd-sized block centered on each pixel; and a transform coefficient processor 25 configured to threshold and scale the transform coefficients in the block, and to invert the thresholded and scaled transform coefficients in that block. As a result of this processing, the transform domain processing module 23 determines a first (e.g., green) color value for each pixel in the input image data.

A reconstruct module 26 is configured to (i) reconstruct each of second and third (e.g., red and blue) color data of the image by determining spatially local maps between the initial first (e.g., green) color data and each of initial second and third (e.g., red and blue) color data of the image and (ii) estimate reconstructed second and third (e.g., red and blue) color data of the image from the reconstructed first (e.g., green) color data obtained using the determined maps. As previously noted, the processing of red and blue color data is done as the corresponding processed green data (e.g., processed green data for all pixels belonging to the neighborhood from which the corresponding red and blue color data are estimated) becomes available.

A hue shift module 27 is configured to correct any hue shift of the reconstructed image, if such correction is necessary or desired. An interpolation module 28 is configured to interpolate the image in case such action is necessary.

The reconstructed image is then transmitted through an output 29 to a rendering device (e.g., a printer or display) for high-resolution rendering.

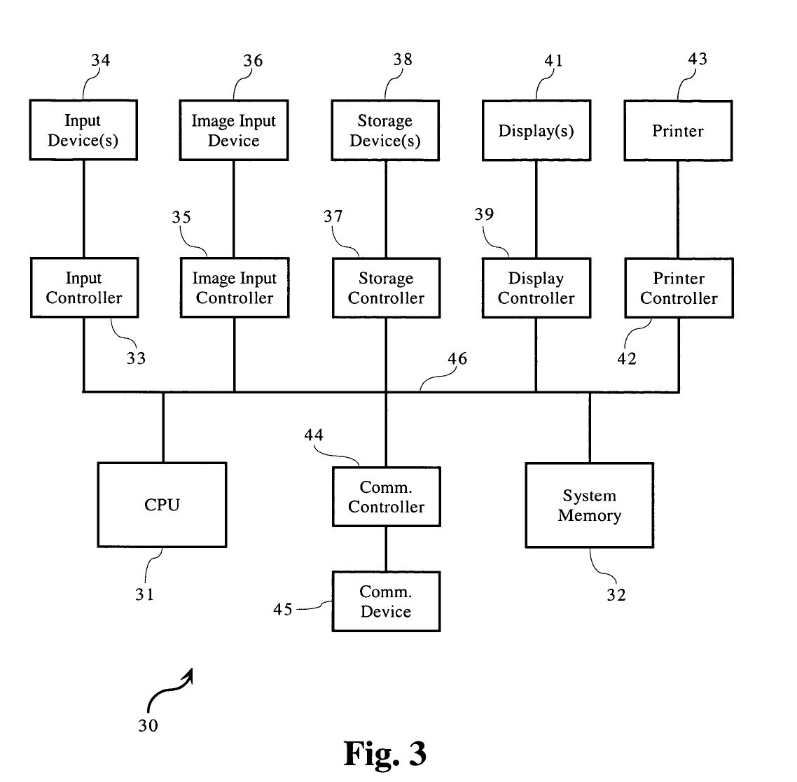

Unit 21 may be embodied in whole or in part on an image processing system 30 of the type illustrated in FIG. 3. This image processing system is essentially a computer with peripheral devices including an image input device and image output devices, i.e., a printer and a display. Such peripheral devices are not required to perform the processing but are shown to illustrate the devices from which the input image can be obtained and the devices on which the processed image can be rendered. The computer itself may be of any style, make and model that is suitable for running the algorithm of the present invention. It should be noted that the algorithm may also be embodied in other suitable arrangements. For example, the inventive algorithm may be embodied directly in the printer.

The illustrated image processing system of FIG. 3 includes a central processing unit (CPU) 31 that provides computing resources and controls the system. CPU 31 may be implemented with a microprocessor or the like, and may also include a floating point coprocessor for mathematical computations. CPU 31 is preferably also configured to process image/graphics, video, and audio data. To this end, the CPU 31 may include one or more other chips designed specifically to handle such processing. System 30 further includes system memory 32 which may be in the form of random-access memory (RAM) and read-only memory (ROM).

Such a system 30 typically includes a number of controllers and peripheral devices, as shown in FIG. 3. In the illustrated embodiment, input controller 33 represents an interface to one or more input devices 34, such as a keyboard, mouse or stylus. There is also a controller 35 which communicates with an image input device 36 which may be any of a variety of low-cost, low-power devices such as a cell phone, web cam, PDA, robot, or equivalent device from which an image may be obtained. A storage controller 37 interfaces with one or more storage devices 38 each of which includes a storage medium such as magnetic tape or disk, or an optical medium that may be used to record programs of instructions for operating systems, utilities and applications which may include embodiments of programs that implement various aspects of the present invention. Storage device(s) 38 may also be used to store input image data and/or output data processed in accordance with the invention. A display controller 39 provides an interface to a display device 41 which may be of any known type. A printer controller 42 is also provided for communicating with a printer 43, which may be a high-resolution printer. The processing of this invention may be embodied in the printer controller 42, e.g., the printer driver.

A communications controller 44 interfaces with a communication device 45 which enables system 30 to connect to remote devices through any of a variety of networks including the Internet, a local or wide area network, or through any suitable electromagnetic carrier signals including infrared signals.

In the illustrated system, all major system components connect to bus 46 which may represent more than one physical bus.

Depending on the particular application of the invention, various system components may or may not be in physical proximity to one another. For example, the input image data and/or the output image data may be remotely received from and/or transmitted to a remote location. Also, a program that implements various aspects of the image processing of this invention may be accessed from a remote location (e.g., a server) over a network. Such data and/or program(s) may be conveyed through any of a variety of machine-readable medium including magnetic tape or disk or optical disc, network signals, or any suitable electromagnetic carrier signal including an infrared signal.

While the present invention may be conveniently implemented with software, a hardware implementation or combined hardware/software implementation is also possible. A hardware implementation may be realized, for example, using ASIC(s), digital signal processing circuitry, or the like. As such, the claim language “machine-readable medium” includes not only software-carrying media, but also hardware having instructions for performing the required processing hardwired thereon, as well as a combination of hardware and software. Similarly, the claim language “program of instructions” includes both software and instructions embedded on hardware. Also, each of the modules and processors referred to in the claims covers any appropriately configured processing device, such as an instruction-driven processor (e.g., a CPU), ASIC, digital signal processing circuitry, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

As the foregoing description demonstrates, the present invention provides a fast and effective way to process images that suffer from noise, artifacts and/or blur-related problems, particularly when scaled up for rendering on a high-resolution device such as an ink-jet printer. The processing of the present invention is quite well suited for use on images obtained from inexpensive sensors that are incorporated in low-cost, low-power devices such as cell phones, cameras, web cams, etc., since such images usually suffer from the very problems this invention is designed to correct.

While the invention has been described in conjunction with several specific embodiments, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

1. A method for processing compressed, noisy digital images, comprising the steps of:
(a) processing initial first color data of an image to obtain reconstructed first color data thereof by
(a)(1) computing a transform representation of initial first color data for each of a plurality of blocks of the image, each computed transform representation comprising a plurality of transform coefficients,
(a)(2) thresholding and scaling the transform coefficients in each block, and
(a)(3) inverting the thresholded and scaled transform coefficients in each block to determine a reconstructed first color value for a designated pixel each block;
(b) determining spatially local maps between at least a portion of the initial first color data and at least corresponding portions of each of initial second and third color data of the image; and
(c) estimating reconstructed second and third color values for the designated pixel in each block from selected reconstructed first color values obtained in step (a) using the maps determined in step (b) to obtain reconstructed second and third color data of the image.

2. The method of claim 1, wherein each of the plurality of blocks encompasses a neighborhood of pixels, each block having a respective designated pixel for which the reconstructed first color value is determined.

3. The method of claim 2, wherein processing step (a) is performed until a reconstructed first color value has been determined for each pixel in a particular neighborhood before proceeding to steps (b) and (c) in which reconstructed second and third color values are estimated for the corresponding designated pixel from the reconstructed first color values in that neighborhood.

4. The method of claim 1, wherein the first color data is green color data, the second color data is red color data, and the third color data is blue color data.

5. The method of claim 4, further comprising the step of performing a hue shift on the reconstructed green, red and blue color data.

6. The method of claim 1, further comprising the step of interpolating the reconstructed image data to a different resolution.

7. The method of claim 1, wherein the thresholding in step (a)(2) is soft-thresholding.

8. An apparatus for processing compressed, noisy digital images, the apparatus comprising:
a transform domain processing module configured to process initial first color data of an image, the transform domain processing module including
a transform block processor configured to compute a transform representation of initial first color data for each of a plurality of blocks of the image, each computed transform representation comprising a plurality of transform coefficients, and
a transform coefficient processor configured to threshold and scale the transform coefficients in each block, and to invert the thresholded and scaled transform coefficients in each block,
whereby the transform domain processing module determines a reconstructed first color value for a designated pixel in each block; and
a reconstruct module configured to (i) determine spatially local maps between at least a portion of the initial first color data and at least corresponding portions of each of initial second and third color data of the image and (ii) estimate reconstructed second and third color values for the designated pixel in each block from selected reconstructed first color values using the determined maps to obtain reconstructed second and third color data of the image.

9. The apparatus of claim 8, wherein each of the plurality of blocks processed by the transform domain processing module encompasses a neighborhood of pixels, each block having a respective designated pixel for which the reconstructed first color value is determined.

10. The apparatus of claim 9, wherein the reconstruct module estimates reconstructed second and third color values for the corresponding designated pixel in a particular neighborhood from the reconstructed first color values in that neighborhood, after a reconstructed first color value has been determined for each pixel in that neighborhood.

11. The apparatus of claim 8, wherein the first color data is green color data, the second color data is red color data, and the third color data is blue color data, and the apparatus further comprises a hue shift module configured to perform a hue shift on the reconstructed green, red and blue color data.

12. The apparatus of claim 8, further comprising an interpolation module configured to interpolate the reconstructed image data to a different resolution.

13. The apparatus of claim 8, wherein the apparatus comprises a computer or printer.

14. A machine-readable medium having a program of instructions for directing a machine to process compressed, noisy digital images, the program of instructions comprising:
(a) instructions for processing initial first color data of an image to obtain reconstructed first color data thereof by
(a)(1) computing a transform representation of initial first color data for each of a plurality of blocks of the image, each computed transform representation comprising a plurality of transform coefficients,
(a)(2) thresholding and scaling the transform coefficients in each block, and
(a)(3) inverting the thresholded and scaled transform coefficients in each block to determine a reconstructed first color value for a designated pixel each block;
(b) instructions for determining spatially local maps between at least a portion of the initial first color data and at least corresponding portions of each of initial second and third color data of the image; and
(c) instructions for estimating reconstructed second and third color values for the designated pixel in each block from selected reconstructed first color values obtained in step (a) using the maps determined in step (b) to obtain reconstructed second and third color data of the image.

15. The machine-readable medium of claim 14, wherein each of the plurality of blocks encompasses a neighborhood of pixels, each block having a respective designated pixel for which the reconstructed first color value is determined.

16. The machine-readable medium of claim 15, wherein processing instructions (a) are performed until a reconstructed first color value has been determined for each pixel in a particular neighborhood before proceeding to instructions (b) and (c) which direct that reconstructed second and third color values be estimated for the corresponding designated pixel from the reconstructed first color values in that neighborhood.

17. The machine-readable medium of claim 14, wherein the first color data is green color data, the second color data is red color data, and the third color data is blue color data.

18. The machine-readable medium of claim 17, further comprising instructions for performing a hue shift on the reconstructed green, red and blue color data.

19. The machine-readable medium of claim 14, further comprising the step of interpolating the reconstructed image data to a different resolution.

20. The machine-readable medium of claim 14, wherein the thresholding in (a)(2) is soft-thresholding.
